(19) United States
(12) Patent Application Publication
(10) Pub. No.: US 2014/0172528 A1
(43) Pub. Date: Jun. 19, 2014

(54) PROVIDING FUTURE ACCESS TO REWARD DISTRIBUTION IN A PURCHASE OFFER AND REWARD SYSTEM

(71) Applicant: BANK OF AMERICA CORPORATION, Charlotte, NC (US)

(72) Inventors: Richard M. Korzenko, Fort Mill, SC (US); Matthew Laine Donlan, Charlotte, NC (US); Ilich Martinez, Waxhaw, NC (US)

(73) Assignee: Bank of America Corporation, Charlotte, NC (US)

(21) Appl. No.: 13/713,538

(22) Filed: Dec. 13, 2012

(51) Int. Cl. G06Q 30/02

(52) U.S. Cl. CPC G06Q 30/0233
USPC 705/14.17

(57) ABSTRACT

Embodiments of the invention are directed to systems, methods and computer program products for managing the distribution of rewards in a purchase offer and reward program. Specifically, embodiments of the present invention provide for applying a monetary reward to a designated account that is only available to the customer in the future based on occurrence of a triggering event. In specific embodiments of the invention, the triggering event may be a future date or an account amount threshold, such that when the date occurs or when the threshold amount is accumulated in the account, the account becomes accessible to the customer. Moreover, the account may be any type of account, such as a savings account or the like. In specific embodiments, the account is associated with a pre-paid credit card or a similar product, such that once the triggering event occurs the pre-paid credit card is issued to the customer.

### FIELD

In general, embodiments of the invention relate to methods, systems, apparatus and computer program products for purchase offer and reward program and, more particularly, providing future access to benefits, such as cash-back, distributed in a purchase offer and reward system based on a future occurrence of a triggering event.

### BACKGROUND

When an entity, such as a financial institution or the like, sends a targeted purchase offer to a potential customer, there is a greater likelihood that the potential customer actually takes advantage of the purchase offer. The targeted purchase offer may result from knowing the customer's purchasing history or preferences. By sending purchase offers to potential customers who will likely use the purchase offers and excluding those who will likely not use the purchase offers, an entity can save millions of dollars in sending out purchase offers to those who will likely not use the purchase offers.

In addition, current purchase offer and reward programs, such as cash-back offer programs are limited by the means in which rewards/benefits are bestowed upon the customer. Typically, in a cash-back reward scenario, the reward is applied to an account held by the customer at the entity implementing the program. For example, in the financial institution implemented cash-back program the reward amount is applied to the customer's checking account, savings account or the like held at the financial institution implementing the program. In such instances, the customer will typically have immediate access to the reward via the checking account or savings account or, at most, next statement cycle access to the reward amount.

Therefore, a need exists to develop unique and inventive ways to distribute rewards/benefits related to purchase offer and reward programs. The desired distribution schemes should not be limited in terms of the accounts that the rewards (e.g., cash-back) can be applied to and should provide the customer with ample flexibility in designated how the reward is distributed. In addition, the desired distribution schemes should provide for the customer to accumulate or save rewards over time, such that the rewards are only available to the customer in the future.

### BRIEF SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for managing the distribution of rewards in a purchase offer and reward program. Specifically, embodiments of the present invention provide for applying a monetary reward to a designated account that is only available to the customer in the future based on occurrence of a triggering event. The customer or the entity implementing the purchase offer and reward program may define the triggering event.

In specific embodiments of the invention, the triggering event may be a future date or an account amount threshold, such that when the date occurs or when the threshold amount is accumulated in the account, the account becomes accessible to the customer (i.e., the customer may withdraw funds, transfer funds out or the like). In such embodiments, the invention may further include monitoring for occurrence of the triggering event, such that when the triggering event occurs the account is automatically accessible to the customer.

In other embodiments, in which the triggering event is defined by the customer, such as based on a specific event (e.g., marriage, graduation or the like) or the customer or someone else meeting a specific goal (e.g., a specific scholastic goal), the customer may monitor for occurrence of the triggering event and, upon the even occurring, provide an input to the system that serves to provide the access to the account.

Additionally, the account to which future access is provided may be internal or, in some embodiments, external to the entity implementing the offer purchase and reward program. Moreover, the account may be any type of account, such as a savings account or the like. In specific embodiments, the account is associated with a pre-paid credit card or a similar product, such that once the triggering event occurs the pre-paid credit card is issued to the customer.

In additional embodiments of the invention, the account to which future access is provided may be held by the customer or, as designated by the customer, an account held by someone other than the customer, such as a family member outside the household, a friend, a charity or the like.

An apparatus for managing rewards in a purchase offer program defines first embodiments of the invention. The apparatus includes a computing platform including a memory and a processor in communication with the memory. The memory further includes a purchase offer program module stored in the memory, executable by the processor, and configured to receive acknowledgement that a customer has redeemed an offer having an associated monetary reward and provide the monetary reward, such as cash-back or the like, to an account that is only available to an account holder based on occurrence of a triggering event occurring in the future.

In specific embodiments of the apparatus, the triggering event may be a date in the future, a threshold amount accumulated in the account or a future life event, such as a graduation, a marriage, home ownership or like.

In specific embodiments of the apparatus, the purchase offer program module is further configured to monitor for occurrence of the triggering event and automatically make the account available to the account holder based on the occurrence of the triggering event. In other embodiments, in which the triggering event is preconfigured by the customer, the customer may monitor for occurrence of the triggering and provides an input to the purchase offer program module to authorize making available the account to the account holder based occurrence the triggering event.

In certain specific embodiments of the apparatus, the account is associated with a pre-paid credit card that is issued upon occurrence of the triggering event. In other specific embodiments of the apparatus, the account holder is someone other than (1) the customer or (2) someone residing in a household of the customer. In still further embodiments of the apparatus, the account is external to the entity implementing the purchase offer program, for example, if the entity implementing the purchase offer program is a financial institution, the external account may be at a retailer/merchant or another financial institution.

A method for managing rewards in a purchase offer program provides for second embodiments of the invention. The method includes receiving, by a computing device processor, acknowledgement that a customer has redeemed an offer having an associated monetary reward, such as cash-back or the like. The method further includes providing, by a computing device processor, the monetary reward to an account that is only available to an account holder based on occurrence of a triggering event occurring in the future.

In certain specific embodiments of the method, the triggering event may be a date in the future, a threshold amount accumulated in the account or a future life event, such as a graduation, a marriage, home ownership or like.

In specific embodiments the method also includes monitoring, by a computing device processor, for occurrence of the triggering event; and automatically providing, by a computing device processor, the account holder access to the account based on the occurrence of the triggering event. In other embodiments of the method, in which the triggering event is preconfigured by the customer, the method may further include receiving, by a computing device processor, an input from the customer that indicates that the triggering event has occurred and, in response to the input, automatically providing, by a computing device processor, the account holder access to the account.

In still further embodiments of the method, the account is associated with a pre-paid credit card that is issued upon occurrence of the triggering event. In other elated embodiments of the method, the account holder is someone other than (1) the customer or (2) someone residing in a household of the customer. In still further embodiments of the method, the account is external to the entity implementing the purchase offer program, for example, if the entity implementing the purchase offer program is a financial institution, the external account may be at a retailer/merchant or another financial institution.

A computer program product for managing rewards in a purchase offer program defines third embodiments of the invention. The computer program product includes a non-transitory computer-readable medium. The medium includes a set of codes for causing a computer to (1) receive acknowledgement that a customer has redeemed an offer having an associated monetary reward and (2) provide the monetary reward to an account that is only available to an account holder based on occurrence of a triggering event occurring in the future.

Thus, further details are provided below for systems, apparatus, methods and computer program products for managing the distribution of rewards in a purchase offer and reward program. Specifically, embodiments of the present invention provide for applying a monetary reward to a designated account that is only available to the customer in the future based on occurrence of a triggering event. In specific embodiments of the invention, the triggering event may be a future date or an account amount threshold, such that when the date occurs or when the threshold amount is accumulated in the account, the account becomes accessible to the customer. In such embodiments, the invention may further include monitoring for occurrence of the triggering event, such that when the triggering event occurs the account is automatically accessible to the customer. In other embodiments, in which the triggering event is defined by the customer, such as based on a specific event or the customer or someone else meeting a specific goal, the customer may monitor for occurrence of the triggering event and, upon the even occurring, provide an input to the system that serves to provide the access to the account.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, where:

FIG. 1 is a block diagram illustrating an apparatus for providing alternative rewards distribution in an offer purchase and reward program, in accordance with embodiments of the present invention;

FIG. 2 is a block diagram illustrating an apparatus for providing future-accessible rewards in an offer purchase and reward program, in accordance with embodiments of the present invention;

FIG. 3 is a flowchart illustrating a general process flow for implementing alternative rewards distribution in an offer purchase and reward program, in accordance with embodiments of the present invention;

FIG. 4 is a flowchart illustrating a general process flow for providing future-accessible rewards in an offer purchase and reward program, in accordance with embodiments of the present invention; and

FIG. 5 is a block diagram illustrating technical components of a system for implementing the various processes described herein, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for managing the distribution of rewards in a purchase offer and reward program. Specifically, embodiments of the present invention provide for applying a monetary reward to a designated account that is only available to the customer in the future based on occurrence of a triggering event. The customer or the entity implementing the purchase offer and reward program may define the triggering event.

In specific embodiments of the invention, the triggering event may be a future date or an account amount threshold, such that when the date occurs or when the threshold amount is accumulated in the account, the account becomes accessible to the customer (i.e., the customer may withdraw funds, transfer funds out or the like). In such embodiments, the invention may further include monitoring for occurrence of the triggering event, such that when the triggering event occurs the account is automatically accessible to the customer.

In other embodiments, in which the triggering event is defined by the customer, such as based on a specific event (e.g., marriage, graduation or the like) or the customer or someone else meeting a specific goal (e.g., a specific scholastic goal), the customer may monitor for occurrence of the triggering event and, upon the even occurring, provide an input to the system that serves to provide the access to the account.

Additionally, the account to which future access is provided may be internal or, in some embodiments, external to the entity implementing the offer purchase and reward program. Moreover, the account may be any type of account, such as a savings account or the like. In specific embodiments, the account is associated with a pre-paid credit card or a similar product, such that once the triggering event occurs the pre-paid credit card is issued to the customer.

In additional embodiments of the invention, the account to which future access is provided may be held by the customer or, as designated by the customer, an account held by someone other than the customer, such as a family member outside the household, a friend, a charity or the like.

In some embodiments, the “entity” implementing the purchase offer and rewards program may be a financial institution, for example a bank implementing a cash-back merchant offer program. In other embodiments, the “entity” may be a merchant or the like. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a customer, referred to herein as a customer, to establish one or more accounts with the entity. An “account” may be the relationship that the customer has with the entity. In the financial institution realm, examples of accounts include a deposit account, such as a transactional account (e.g., a banking account), a savings account, an investment account, a money market account, a time deposit, a demand deposit (i.e., a checking account), a pre-paid account, a credit account, a non-monetary customer profile that includes only personal information associated with the customer, or the like. The account is associated with and/or maintained by the entity. In other embodiments, an entity may not be a financial institution. In still other embodiments, the entity may be the merchant itself.

In some embodiments, the customer is the account holder or a person who has an account (e.g., banking account, credit account, or the like) at the entity implementing the purchase offer and rewards program. As explained herein, a customer may also refer to a family or a household comprising a plurality of customers (e.g., husband, wife, and kids). The account information and/or customer information associated with the various customers in the household may be considered cumulatively for various purposes described herein. The account information may comprise account information associated with a single account that is accessible to the various customers in the household, or may comprise account information associated with separate accounts associated with various individual customers in the household.

As an example of how a purchase offer and rewards program may be implemented, an entity (e.g., a financial institution) may send an offer to a customer (e.g., an account holder). The offer may be presented to the customer via at least one of the customer's electronic banking account (e.g., online banking account, mobile banking account on a portable mobile communication device, or the like), the customer's social network account, email, or text message.

In some embodiments, the presented offer is an offer to receive at least one of a discount or a rebate on at least one of a purchase previously made by the customer (e.g., a previous transaction associated with the customer's financial institution account), a purchase from a merchant from which the customer previously made a purchase, an alternative to the purchase previously made by the customer, or an alternative to the purchase from the merchant from which the customer previously made a purchase. The alternative to the purchase may be determined based on transaction histories associated with a plurality of financial institution accounts associated with multiple customers.

In some embodiments, the presented offer is an offer to receive at least one of a discount or a rebate on a product or service related to a previous purchase made by the customer. For example, if the customer previously bought a stove, the offer is a discount or rebate for a dishwasher or a stove maintenance service.

In some embodiments, an offer that is sent to or presented on a financial institution account associated with a first member of a family may be used (or redeemed) by a second member of the family. In some embodiments, the second member of the family may use the offer even if the second member is not associated with the financial institution account associated with the first member. For example, the offer associated with a particular merchant may be transmitted to (or linked to) a credit card account associated with a first family member. When the second member of the family makes a purchase that qualifies for the offer using the second member's credit card (or any other qualifying payment method), the second member receives the rebate after making the purchase. The financial institution may have access to information that indicates that the second member is a family member of the first member even if the second member is not listed as being associated with the financial institution account associated with the first member.

Additionally, in some embodiments, as part of the previously described offer reconciliation process at the time of settlement of the offer, the system determines whether the account information substantially matches the offer information. If the account information has changed since the purchase transaction such that the account information no longer substantially matches the offer information, the offer may be deemed to be invalid and the financial institution does not provide a rebate to the customer's financial institution account. However, in other embodiments, even if the account information has changed since the purchase transaction, the offer remains valid and the financial institution provides a rebate to the customer's financial institution account.

In some embodiments, the customer may select an option associated with the presented offer to accept the offer. When the customer accepts the offer, the offer is activated so that if the customer uses an eligible payment method (as determined by the entity or the merchant) to make a purchase associated with the offer, the customer receives the monetary reward associated with the offer. In other embodiments, the offer may be automatically activated if the customer has previously chosen to automatically activate offers associated with particular offer types (e.g., associated with particular merchants or product or service types). In some embodiments, the entity or the merchant may determine that a customer may choose among multiple eligible payment methods in order to make a purchase associated with the offer.

As an example, the activated offer may be a rebate of $5 on a purchase of $20 from a department store. The customer may decide to use the offer by visiting the department store and making a purchase of $20. In some embodiments, at the point of sale, the customer pays $20 for the customer's purchase using an eligible payment method determined by the financial institution or the merchant (e.g., payment card, mobile device payment, check, or the like). When the transaction is processed by the financial institution at a predetermined settlement time in the future (e.g., as part of a periodic batch processing operation to generate monthly account statements), the financial institution provides a rebate of $5 to the customer's financial institution account. Therefore, the department store, at the point of sale, may have no knowledge that the customer will receive a rebate at some point in the future. In some embodiments, even the customer may not be aware of the rebate at the point of sale (e.g., if the offer was automatically activated). In other embodiments, the point of sale terminal may provide an indication to at least one of the department store or the customer that the customer will receive a rebate at some point in the future.

In some embodiments, the system described herein may determine that the customer has activated an offer, but has not made a purchase associated with the offer for a predetermined period after activating the offer. Additionally, the system may determine, based on the customer's account information (e.g., transaction history), that the customer has made purchases for goods or services at a merchant that competes with the merchant associated with the activated offer. In order to encourage the customer to make a purchase associated with the activated offer, the system may adjust the offer (e.g., increase the rebate or discount amount associated with the offer, replace the merchant associated with the offer with the merchant from which the customer made purchases during the predetermined period, or the like). The offer adjustment may be communicated to the customer to encourage the customer to make a purchase associated with the adjusted offer. Additionally or alternatively, the system may, at the time of settlement of the customer's purchase made during the predetermined period after activating the offer, substitute the offer with the adjusted offer (may be referred to as the second offer) so that the customer receives a discount or rebate on the customer's purchase. Prior to applying the adjusted offer, the system determines whether the customer qualifies for the adjusted offer.

In some embodiments, the system described herein may determine that the customer does not activate offers associated with a particular merchant (and/or service or good), but has made purchases from a competing merchant for similar services or goods. Based on this determination, the system may, in the future, transmit to the customer offers associated with the merchant from which the customer made purchases. In other embodiments, at the time of settlement of the customer's purchases, the system applies an offer associated with the merchant from which the customer made purchases. Prior to applying the offer, the system determines whether the customer qualifies for the offer.

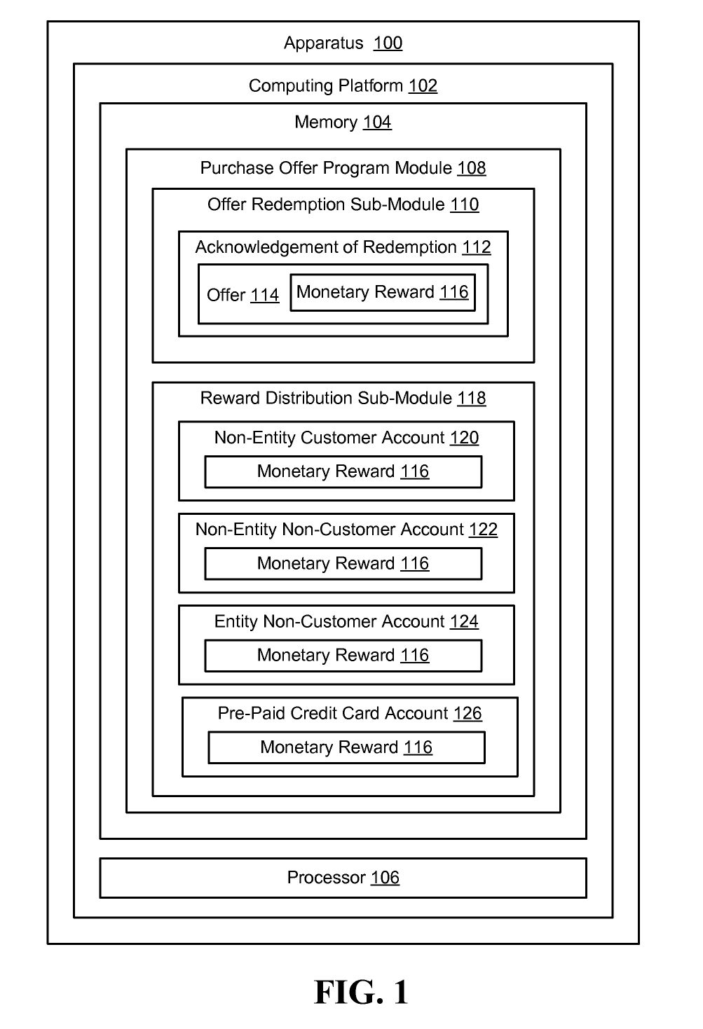

Referring to FIG. 1 a block diagram is presented that illustrates an apparatus 100 configured for providing alternative rewards distribution in an offer purchase and rewards program, in accordance with embodiments of the present invention. The apparatus 100 includes a computing platform 102 having a memory 104 and a processor 106 that is in operable communication with the memory. The memory 104 of apparatus 100 includes a purchase offer program module 108 that is executable by the processor 106 and configured to provide offers to customers of an entity, track customer acceptance and redemption of offers and provide rewards, such as rebates, cash-back or the like, to customers upon acknowledgement that a customer has redeemed an award. In accordance with embodiments of the present invention, the purchase offer program module 108 is configured to provide rewards to accounts other than accounts held by the customer (or someone residing in the household of the customer) at the entity implementing the offer purchase and rewards program, for example, a financial institution, merchant or the like.

The purchase offer program module 108 includes offer redemption sub-module 110 that is configured to receive an acknowledge 112 that a customer has redeemed an offer 114 provided for by the purchase offer program 108. The offer 114 has an associated monetary reward 116, such as a reward or a cash-back incentive associated with redeeming the offer 114. It should be noted that the offer 114 may have some other type of benefit associated therewith, however; if the benefit can be monetized, such that it can be deposited in an account as some type of credit, the benefit qualifies as a monetary reward under embodiments of the present invention.

The purchase offer program module 108 additionally includes reward distribution sub-module 118 that is configured to distribute/deposit the monetary reward 116 in an account other than a customer account (or an account held by a household member that is linked to a customer account) held at the entity implementing the purchase offer and rewards program, such as held at a financial institution or a merchant.

In specific embodiments of invention, the account may include an account 120 held by the customer the purchase offer and rewards program For example, if the entity implementing the purchase offer and rewards program is a financial institution, the entity at which the account is held may be another financial institution (e.g., Bank “A” vs. Bank “B”), a merchant or the like. The account held by the customer at the other entity may be any type of account, for example, a retirement account, a mortgage account, a credit/payment account or the like.

In other specific embodiments of invention, the account may include an account 124, 122 held by someone other than the customer (or someone not in the household of the customer having an account linked to a customer account) at the entity implementing the purchaser offer and rewards program (124) or the purchase offer and rewards program (122). The account held by someone other than the customer at the other entity may include any type of account, such as a savings account, a demand deposit account, a loan account, a credit/payment account, a charity account or the like.

In still further embodiments of the invention, the account may include associated with a pre-paid credit card 126. In such embodiments the account 126 may be configured, by the customer or the entity implementing the program, such that the pre-paid credit card is issued to the customer, or someone else as designated by the customer, based on the balance of the account 126 reaching a preconfigured amount, for example, when $25 in rewards are accumulated in the account 126, a corresponding pre-paid credit card is issued in the amount of $25.

In optional embodiments of the invention, the purchase offer and rewards program is configured such that the customer can pre-configure which account or accounts are designated for monetary rewards resulting from redeeming an offer from the purchase offer and reward program. In such embodiments, the customer may use an interface provided within a network-based website or application, for example, an online banking or mobile banking application, a merchant website or the like, to designate which account or account rewards are to be applied to monetary rewards. Moreover, the purchase offer and rewards program may be configured such that the customer can designate an account for depositing the reward based on parameters associated with the offer and/or the reward. For example the parameters may include, but are not limited to, the type of product/service associated with the offer, the purchase amount, the merchant associated with the offer, the date of redemption, the purchase type used to redeem the offer, the redeeming party/individual, the amount of the monetary reward or the like.

In related embodiments of the invention, the purchase offer and rewards program is configured such that the customer can configure, on-the-fly, proximate to the time when an offer is redeemed, which account or accounts are designated for monetary rewards resulting from redeeming an offer from the purchase offer and reward program. For example, once an offer is redeemed (i.e., a related transaction is conducted) the customer may be sent a communication, in the form of a Short Message Service (SMS)/text message, email or the like, which alerts the customer that an offer has been redeemed and asks the customer to designate an account for depositing the monetary reward or asks the customer to confirm or change a pre-configured account designated for reward deposit. The communication may include a network-accessible link that provides the customer access to configuration of reward distribution account options. In this instance, the customer may configure reward account distribution on an offer redemption-to-offer redemption basis.

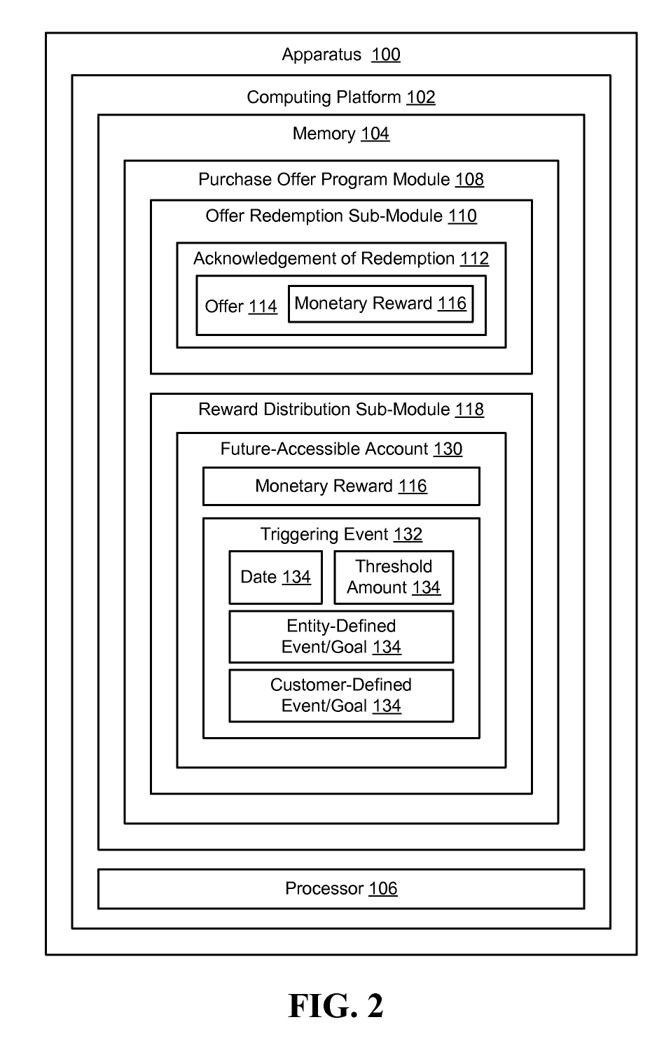

Referring to FIG. 2 a block diagram is presented that illustrates an apparatus 100 configured for providing alternative rewards distribution in an offer purchase and rewards program, in accordance with embodiments of the present invention. The apparatus 100 includes a computing platform 102 having a memory 104 and a processor 106 that is in operable communication with the memory. The memory 104 of apparatus 100 includes a purchase offer program module 108 that is executable by the processor 106 and configured to provide offers to customers of an entity, track customer acceptance and redemption of offers and provide rewards, such as rebates, cash-back or the like, to customers upon acknowledgement that a customer has redeemed an award. In accordance with embodiments of the present invention, the purchase offer program module 108 is configured to provide rewards to accounts other than accounts held by the customer (or someone residing in the household of the customer) at the entity implementing the offer purchase and rewards program, for example, a financial institution, merchant or the like.

The purchase offer program module 108 includes offer redemption sub-module 110 that is configured to receive an acknowledge 112 that a customer has redeemed an offer 114 provided for by the purchase offer program 108. The offer 114 has an associated monetary reward 116, such as a reward or a cash-back incentive associated with redeeming the offer 114. It should be noted that the offer 114 may have some other type of benefit associated therewith, however; if the benefit can be monetized, such that it can be deposited in an account as some type of credit, the benefit qualifies as a monetary reward under embodiments of the present invention.

The purchase offer program module 108 additionally includes rewards distribution sub-module 118 that is configured to distribute/deposit the monetary reward 116 in an account that is only accessible to the account holder based on occurrence of a triggering event 132 occurring in the future. It should be noted that the account holder may be the customer (including household members with accounts linked to a customer account) or some other individual or entity designated by the customer. In addition, the account may be an account held at the entity implementing the purchase offer and reward program, or in other specific embodiments of the invention, the account may be held at another external entity (e.g., if the entity implementing the program is a financial institution the other entity may be a different financial institution, a merchant or the like).

In specific embodiments of the invention, the triggering event is a date 134 in the future. The date 134 may be any date in the future as configured by the entity implementing the purchase offer program or by the customer. For example, the date may coincide with the occurrence of an event in the life of the customer and/or account holder.

In other embodiments of the invention, the triggering event 132 is a threshold amount in the account 130, such that once the threshold amount 136 exists in the account, through rewards distributions into the account or, in some embodiments, additional deposits by the customer into the account, the account holder is able to access the funds in the account. The threshold amount 136 may be configured by the customer or the entity implementing the purchase offer and rewards program. In specific embodiments of the invention, the account may be associated with a pre-paid credit card or the like, such that when the threshold amount 136 is reached or exceeded a pre-paid credit card is issued to the customer or some other individual as designated by the customer.

In still further embodiments of the invention, the triggering event 132 may be an event or goal defined by the entity 138 implementing the program. The event or goal may be associated with the customer's performance as it pertains to the entity, for example, paying off a loan, use of new technologies/transaction channels offered by the entity, viewing/attending marketing seminars or the like. In such embodiments the entity may electronically monitor for occurrence of the triggering event and, upon confirmation that the triggering event has occurred, automatically provide the account holder access to the account based on the occurrence of the triggering event.

In other embodiments of the invention, the triggering event 132 may be an event or goal defined by the customer 140. The event or goal may be any event or goal that the customer desires to associate with making the account available to the account holder. For example, scholastic performance or behalf of the customer of child of the customer, graduation of the customer or a child of the customer, or the like. In such embodiments, the customer may manually monitor for the occurrence of the triggering event 132 and, upon confirmation that the triggering event has occurred, provide an input to the purchase offer program module 108 that indicates that the triggering event 132 has occurred. Such an input by the customer provides the account holder access to the funds in the account.

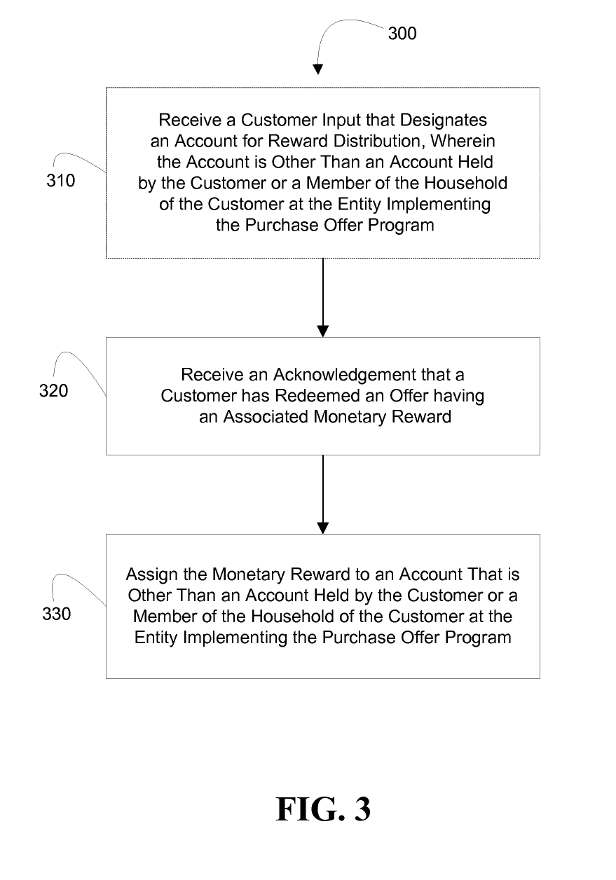

Turning the reader's attention to FIG. 3, a flow diagram is presented of a method 300 for distribution of rewards in an offer purchase and rewards program, in accordance with embodiments of the present invention. At optional Event 310, a customer input is received that designates an account for reward distribution. The account is an account other than one held by the customer (or a member of the customer's household linked to an account held by the customer) at the entity implementing the purchase offer program.

In specific embodiment of the method, the customer input is received at a user interface, associated with an online or mobile banking application, a merchant website or the like, in advance of redeeming offers, such that the inputs designate the reward distribution account for future offers presented and/or redeemed by the customer. In such embodiments, the user interface may be further configured to receive additional user inputs that define parameters for designating accounts for reward distribution. For example, parameters may include, but are not limited to, the type of product/service associated with the offer, the purchase amount, the merchant associated with the offer, the date of redemption, the purchase type used to redeem the offer, the redeeming party/individual, the amount of the monetary reward or the like. Thus, the customer may designate one account for distribution of rewards associated with one specific offer type and designate another account for distribution of rewards associated with another specific offer type and so on. It should be noted that the present invention requires that at least one but not all of the designated accounts for reward distribution need to be an account other than one held by the customer at the entity implementing the purchase offer program.

In other specific embodiments of the method, the customer input is received at a user interface, proximate in time to the completion of a transaction associated with a program offer, such that the input designates, on-the-fly, the reward distribution account for the current transaction. For example, the customer may receive a communication, such as a text or email that notifies that they just completed a transaction that redeems an offer. The communication may provide a link to a network-accessible means for designating an account for the reward associated with the transaction or communication may acknowledge a pre-configured account for reward distribution and require the customer to activate the link to make changes to the pre-configured account for this particular transaction. As the examples illustrate, such embodiments of the invention provide for reward distribution accounts to be designated on an offer transaction-to-offer transaction basis.

At Event 320, an acknowledgement is received that a customer has redeemed an offer having an associated monetary reward. Such acknowledgement may prompt the purchase offer and rewards system to access the customer's profile to determine the pre-configured account designated for reward distribution or the acknowledgement may prompt generation and communication of the communication asking the customer to choose, confirm or change a designated account for rewards distribution.

At Event 330, the monetary rewards associated with the offer is assigned to the account designated by the customer, such that the designated account is one other than an account held by the customer at the entity implementing the purchase offer program. In specific embodiments of the method, the monetary reward may be provided to an account held by the customer (or a linked member of the customer's household) at another entity other than the entity implementing the program. For example, if the entity implementing the program is a financial institution, the other entity may a different financial institution or a merchant. In other embodiments of the invention, the monetary reward may be provided to an account held by someone other than the customer (or a linked member of the customer's household) as designated by the customer. The account may be held at the same entity as the entity implementing the purchase offer program or, in other embodiments of the method, the account may be held at other entities than the entity implementing the purchase offer program.

In still further embodiments of the invention, the account may be associated with a pre-paid credit card that is issued to the customer or someone designated by the customer. In such embodiments, the account may be configured such that a threshold amount in the account triggers issuance of the pre-paid credit card or, in other embodiments, the customer or the entity implementing the program, may dictate/request when the pre-paid card is issued, based on a schedule or based on the amount in the account.

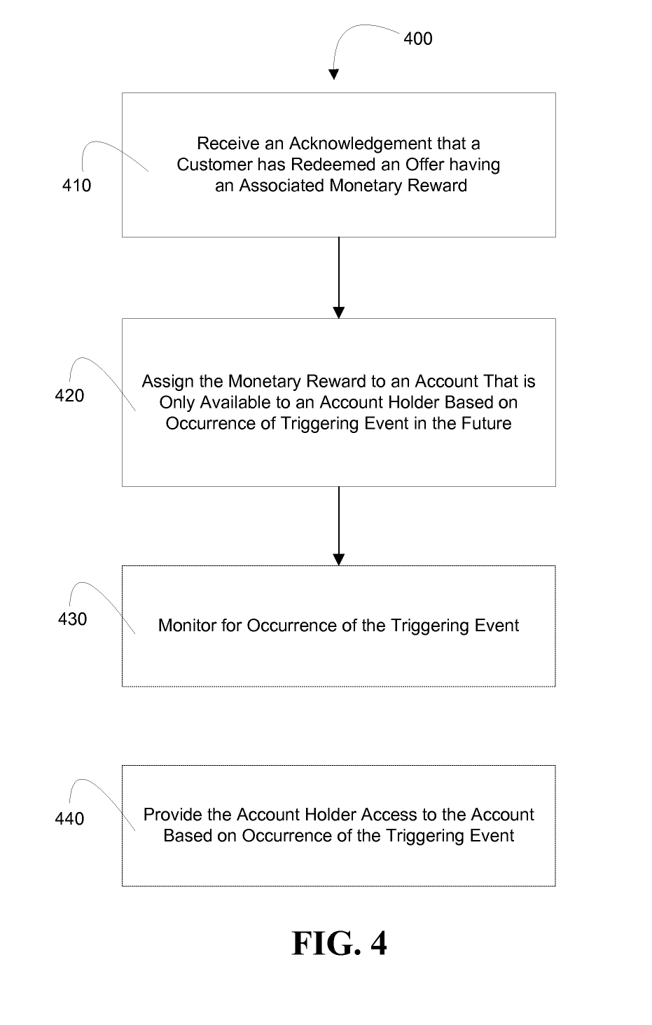

Referring to FIG. 4 a flow diagram is presented of a method 400 for distribution of rewards in an offer purchase and rewards program, in accordance with embodiments of the present invention. At Event 410, an acknowledgement is received that a customer has redeemed an offer having an associated monetary reward. Such acknowledgement may prompt the purchase offer and rewards system to access the customer's profile to determine the pre-configured account designated for reward distribution or the acknowledgement may prompt generation and communication of an alert asking the customer to choose, confirm or change a designated account for rewards distribution.

At Event 420 the monetary reward is assigned or otherwise deposited in an account that is only available to the account holder based on occurrence of a triggering event. In specific embodiments of the method the triggering event may be a data defined by the customer or the entity implementing the purchase offer and reward program. In other specific embodiment of the method the triggering may be a predetermined threshold amount in the account, such that meeting or exceeding the threshold amount provides the account holder access to the account. In such embodiments the threshold amount may be configured by the customer or the entity implementing the purchase offer and reward program. In other embodiments of the method the triggering event may be any event or goal as defined by the customer or the entity implementing the purchase offer and reward program. In addition, according to embodiments of the method, the account holder may be the customer (including a linked member of the customer's household) or any other individual or entity designated by the customer. Additionally, according to specific embodiments of the method, the account may be held at the entity implementing the purchase offer program or, optionally, held externally from the entity implementing the purchase offer program, for example, at another financial institution, a merchant or the like. Moreover, the account may be configured such that once the triggering event occurs access is provided by issuing a pre-paid credit card or the like to the customer or an individual designated by the customer.

At optional Event 430, monitoring of the triggering event occurs. In certain embodiments in which the triggering event is a date, an account threshold amount or the like, the monitoring of the occurrence of the triggering event will be an automated function carried out by the purchase offer and reward program or some other system. In other embodiments of the invention, in which the triggering event is manually monitored by the customer and/or the entity implementing the purchase offer program, acknowledgement of the occurrence of the triggering event may require an input to the purchase offer program system in order to provide the account holder access to the funds in the account.

At optional Event 440, the account holder is provided access to the account based on the occurrence of the triggering event. In specific embodiments in which the monitoring of the occurrence of the triggering event is automated, the account holder is provided automated access to the account in response to the occurrence of the triggering event. In other embodiments in which the monitoring is performed at least partially by manually observation/confirmation of the triggering event, the account holder is provided access to the account once an input is provided to the system by the customer and/or the entity implementing the purchase offer program confirming occurrence of the triggering event. A communication, such as an email or text message may be sent to the account holder notifying the account holder that access to the funds in the account is now available.

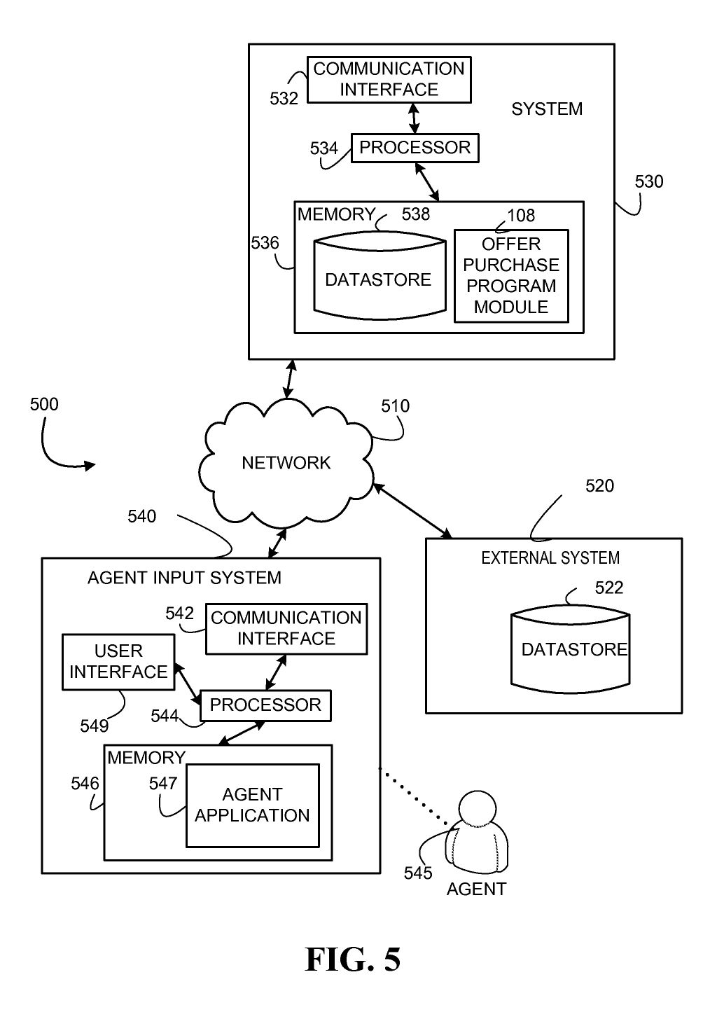

Referring now to FIG. 5, FIG. 5 presents an exemplary block diagram of the system environment 500 for implementing any of the process flows described herein, in accordance with embodiments of the present invention. As illustrated, the system environment 500 includes a network 510, an external system 520, a system 530, and an agent input system 540. Also shown in FIG. 5 is an agent 545 of the agent input system 540. The agent 545 may be a person who uses the agent input system 540 to execute an agent application 547 or uses the agent input system 540 to initiate execution of a purchase offer program module 537. The agent application 547 and/or the purchase offer program module 537 may incorporate one or more parts of the process flows described herein. The agent may be an employee of the entity that manages the system 530 and/or the external system 520. In other embodiments, the agent may not be an employee of an entity, but may still provide a service under the direction and/or supervision of the entity. Alternatively, the agent input system 540 may be a customer input system associated with a customer of a financial institution account as described herein. The features associated with the agent input system 540 are also applicable to the customer input system. As described herein, a customer input system may be a personal or portable computer, a portable mobile device such as a portable mobile telecommunication device or a portable tablet computer.

As shown in FIG. 5, the external system 520, the system 530, and the agent input system 540 are each operatively and selectively connected to the network 510, which may include one or more separate networks. In addition, the network 510 may include a local area network (LAN), a wide area network (WAN), and/or a global area network (GAN), such as the Internet. The network may also include a mobile telecommunication network. It will also be understood that the network 510 may be secure and/or unsecure and may also include wireless and/or wireline and/or optical interconnection technology.

The external system 520 may be any computing or non-computing system that transmits information to the system 530. Additionally or alternatively, information from the system 530 may be transmitted to the external system 520. As presented in FIG. 5, the external system 520 comprises at least one datastore 522. The datastore 522 may comprise information relating to at least one of the customer, the customer's financial institution account, offers, rules related to targeting offers to customers, rules related to designating which accounts to apply to a specified reward, personal information, or the like. As used herein, the terms “data” and “information” may be used interchangeably.

The agent input system 540 may include any computerized apparatus that can be configured to perform any one or more of the functions of the agent input system 540 described and/or contemplated herein. For example, the agent 545 may use the agent input system 540 to transmit and/or receive information or commands to and from the system 530. In some embodiments, for example, the agent input system 540 may include a personal computer system, a mobile computing device, a mobile phone, a personal digital assistant, a network device, a mobile phone, and/or the like. As illustrated in FIG. 5, in accordance with some embodiments of the present invention, the agent input system 540 includes a communication interface 542, a processor 544, a memory 546 having an agent application 547 stored therein, and an agent interface 549. In such embodiments, the communication interface 542 is operatively and selectively connected to the processor 544, which is operatively and selectively connected to the agent interface 549 and the memory 546. In some embodiments, the agent 545 may use the agent application 547 to execute processes described with respect to the process flows described herein, or may initiate the system 530 to execute the process flows described herein. For example, the agent 545 may use the agent application 547 to configure which accounts to designate for program rewards.

Each communication interface described herein, including the communication interface 542, generally includes hardware, and, in some instances, software, that enables the agent input system 540, to transport, send, receive, and/or otherwise communicate information to and/or from the communication interface of one or more other systems on the network 510. For example, the communication interface 542 of the agent input system 540 may include a modem, transceiver, server, electrical connection, and/or other electronic device that operatively connects the agent input system 540 to another system such as the system 530. A transceiver may include radio circuitry for wirelessly transmitting and receive information.

Each processor described herein, including the processor 544, generally includes circuitry for implementing the audio, visual, and/or logic functions of the agent input system 540. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the agent application 547 of the memory 546 of the agent input system 540.

Each memory device described herein, including the memory 546 for storing the agent application 547 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 5, the memory 546 includes the agent application 547. In some embodiments, the agent application 547 includes an interface for communicating with, navigating, controlling, configuring, and/or using at least one of the system 530 or the agent input system 540. In some embodiments, the agent application 547 includes computer-executable program code portions for instructing the processor 544 to perform one or more of the functions of the agent application 547 described and/or contemplated herein. In some embodiments, the agent application 547 may include and/or use one or more network and/or system communication protocols.

Also shown in FIG. 5 is the user interface 549. In some embodiments, the user interface 549 includes one or more output devices, such as a display and/or speaker, for presenting information to the agent 545. In some embodiments, the user interface 549 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the agent 545. In some embodiments, the user interface 549 includes the input and display devices of a personal computer, such as a keyboard and monitor, which are operable to receive and display information.

FIG. 5 also illustrates a system 530, in accordance with an embodiment of the present invention. The system 530 may include any computerized apparatus that can be configured to perform any one or more of the functions of the system 530 described and/or contemplated herein. In accordance with some embodiments, for example, the system 530 may include a computer network, an engine, a platform, a server, a database system, a front end system, a back end system, a personal computer system, and/or the like. In some embodiments, such as the one illustrated in FIG. 5, the system 530 includes a communication interface 532, a processor 534, and a memory 536, which includes a purchase offer program module 537 and a datastore 538 stored therein. As shown, the communication interface 532 is operatively and selectively connected to the processor 534, which is operatively and selectively connected to the memory 536.

It will be understood that the purchase offer program module 537 may be configured to implement any one or more portions of the various user interfaces and/or process flow described herein. It will also be understood that, in some embodiments, the memory includes other applications. It will also be understood that, in some embodiments, the purchase offer program module 537 is configured to communicate with the datastore 538, the agent input system 540 and/or the external system 520.

It will be further understood that, in some embodiments, the purchase offer program module 537 includes computer-executable program code portions for instructing the processor 534 to perform any one or more of the functions of the purchase offer program module 537 described and/or contemplated herein. In some embodiments, the purchase offer program module 537 may include and/or use one or more network and/or system communication protocols.

In addition to the purchase offer program module 537, the memory 536 also includes the datastore 538. As used herein, the datastore 538 may be one or more distinct and/or remote datastores. In some embodiments, the datastore 538 is not located within the system and is instead located remotely from the system. In some embodiments, the datastore 538 stores information or data described herein. For example, the datastore 538 may store information relating to at least one of the customer, the customer's financial institution account, offers, rules related to targeting offers to customers, rules related to which account(s) the customers have designated for applying the reward, personal information, or the like.

It will be understood that the datastore 538 may include any one or more storage devices, including, but not limited to, datastores, databases, and/or any of the other storage devices typically associated with a computer system. It will also be understood that the datastore 538 may store information in any known way, such as, for example, by using one or more computer codes and/or languages, alphanumeric character strings, data sets, figures, tables, charts, links, documents, and/or the like. Further, in some embodiments, the datastore 538 may include information associated with one or more applications, such as, for example, the purchase offer program module 537. It will also be understood that, in some embodiments, the datastore 538 provides a substantially real-time representation of the information stored therein, so that, for example, when the processor 534 accesses the datastore 538, the information stored therein is current or substantially current.

It will be understood that the embodiment of the system environment illustrated in FIG. 5 is exemplary and that other embodiments may vary. As another example, in some embodiments, the system 530 includes more, less, or different components. As another example, in some embodiments, some or all of the portions of the system environment 500 may be combined into a single portion. Likewise, in some embodiments, some or all of the portions of the system 530 may be separated into two or more distinct portions.

In addition, the various portions of the system environment 500 may be maintained for and/or by the same or separate parties. For example, the system 530 and the external system 520 may be maintained by separate parties.

It will also be understood that the system 530 may include and/or implement any embodiment of the present invention described and/or contemplated herein. For example, in some embodiments, the system 530 is configured to implement any one or more of the embodiments of the process flows described and/or contemplated herein.

Thus, systems, apparatus, methods and computer program products are described at length above which provide for managing the distribution of rewards in a purchase offer and reward program. Specifically, embodiments of the present invention provide for applying a monetary reward to a designated account that is only available to the customer in the future based on occurrence of a triggering event. In specific embodiments of the invention, the triggering event may be a future date or an account amount threshold, such that when the date occurs or when the threshold amount is accumulated in the account, the account becomes accessible to the customer. In such embodiments, the invention may further include monitoring for occurrence of the triggering event, such that when the triggering event occurs the account is automatically accessible to the customer. In other embodiments, in which the triggering event is defined by the customer, such as based on a specific event or the customer or someone else meeting a specific goal, the customer may monitor for occurrence of the triggering event and, upon the even occurring, provide an input to the system that serves to provide the access to the account.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for managing rewards in a purchase offer program, the apparatus comprising:
a computing platform including a memory and a processor in communication with the memory;
a purchase offer program module stored in the memory, executable by the processor, and configured to:
receive acknowledgement that a customer has redeemed an offer having an associated monetary reward, and
provide the monetary reward to an account that is only available to an account holder based on occurrence of a triggering event occurring in the future.

2. The apparatus of claim 1, wherein the purchase offer program module is further configured to monitor for occurrence of the triggering event and automatically making the monetary reward available to the account holder based on the occurrence of the triggering event.

3. The apparatus of claim 1, wherein the purchase offer program module is further configured to provide the monetary reward to the account that is only available to the account holder based on the occurrence of the triggering event, wherein the triggering event is a date in the future.

4. The apparatus of claim 1, wherein the purchase offer program module is further configured to provide the monetary reward to the account that is only available to the account holder based on the occurrence of the triggering event, wherein the triggering event is a threshold amount accumulated in the account.

5. The apparatus of claim 1, wherein the purchase offer program module is further configured to provide the monetary reward to the account that is only available to the account holder based on the occurrence of the triggering event, wherein the triggering event is preconfigured by the customer.

6. The apparatus of claim 5, wherein the purchase offer program module is further configured to provide the monetary reward to the account that is only available to the account holder based on the occurrence of the triggering event, wherein the customer monitors occurrence of the triggering and provides an input to the purchase offer program module to authorize making available the account to the account holder based occurrence the triggering event.

7. The apparatus of claim 1, wherein the purchase offer program module is further configured to provide the monetary reward to the account that is only available to the account holder based on the occurrence of the triggering event, wherein the account is associated with a pre-paid credit card that is issued upon occurrence of the triggering event.

8. The apparatus of claim 1, wherein the purchase offer program module is further configured to provide the monetary reward to the account that is only available to the account holder based on the occurrence of the triggering event, wherein the account holder is someone other than (1) the customer or (2) someone residing in a household of the customer.

9. The apparatus of claim 1, wherein the purchase offer program module is further configured to provide the monetary reward to the account that is only available to the account holder based on the occurrence of the triggering event, wherein the account is external to the entity implementing the purchase offer program.

10. A method for managing rewards in a purchase offer program, the method comprising:
receiving, by a computing device processor, acknowledgement that a customer has redeemed an offer having an associated monetary reward; and
providing, by a computing device processor, the monetary reward to an account that is only available to an account holder based on occurrence of a triggering event occurring in the future.

11. The method of claim 10, further comprising:
monitoring, by a computing device processor, for occurrence of the triggering event; and
automatically providing, by a computing device processor, the account holder access to the account based on the occurrence of the triggering event.

12. The method of claim 10, wherein providing the monetary reward further comprises providing, by a computing device processor, the monetary reward to the account that is only available to the account holder based on the occurrence of the triggering event, wherein the triggering event is a date in the future.

13. The method of claim 10, wherein providing the monetary reward further comprises providing, by a computing device processor, the monetary reward to the account that is only available to the account holder based on the occurrence of the triggering event, wherein the triggering event is a threshold amount accumulated in the account.

14. The method of claim 10, wherein providing the monetary reward further comprises providing, by a computing device processor, the monetary reward to the account that is only available to the account holder based on the occurrence of the triggering event, wherein the triggering event is preconfigured by the customer.

15. The method of claim 14, further comprising:
receiving, by a computing device processor, an input from the customer that indicates that the triggering event has occurred; and
in response to the input, automatically providing, by a computing device processor, the account holder access to the account.

16. The method of claim 10, wherein providing the monetary reward further comprises providing, by a computing device processor, the monetary reward to the account that is only available to the account holder based on the occurrence of the triggering event, wherein the account is associated with a pre-paid credit card that is issued upon occurrence of the triggering event.

17. The method of claim 10, wherein providing the monetary reward further comprises providing, by a computing device processor, the monetary reward to the account that is only available to the account holder based on the occurrence of the triggering event, wherein the account holder is someone other than (1) the customer or (2) someone residing in a household of the customer.

18. The method of claim 10, providing the monetary reward further comprises providing, by a computing device processor, the monetary reward to the account that is only available to the account holder based on the occurrence of the triggering event, wherein the account is external to the entity implementing the purchase offer program.

19. A computer program product for managing rewards in a purchase offer program, the computer program product comprising:
a non-transitory computer-readable medium comprising a set of codes for causing a computer to:
receive acknowledgement that a customer has redeemed an offer having an associated monetary reward; and
provide the monetary reward to an account that is only available to an account holder based on occurrence of a triggering event occurring in the future.

20. The computer program product of claim 19, wherein the set of codes further cause the computer to:
monitor for occurrence of the triggering event; and
automatically provide the account holder access to the account based on the occurrence of the triggering event.

21. The computer program product of claim 19, wherein the set of codes for causing the computer to provide the monetary reward further cause the computer to provide the monetary reward to the account that is only available to the account holder based on the occurrence of the triggering event, wherein the triggering event is a date in the future.

22. The computer program product of claim 19, wherein the set of codes for causing the computer to provide the monetary reward further cause the computer to provide the monetary reward to the account that is only available to the account holder based on the occurrence of the triggering event, wherein the triggering event is a threshold amount accumulated in the account.

23. The computer program product of claim 19, wherein the set of codes for causing the computer to provide the monetary reward further cause the computer to provide the monetary reward to the account that is only available to the account holder based on the occurrence of the triggering event, wherein the triggering event is preconfigured by the customer.

24. The computer program product of claim 23, wherein the set of codes for causing the computer to provide the monetary reward further cause the computer to:
receive an input from the customer that indicates that the triggering event has occurred; and
in response to the input, automatically provide the account holder access to the account.

25. The computer program product of claim 19 wherein the set of codes for causing the computer to provide the monetary reward further cause the computer to provide the monetary reward to the account that is only available to the account holder based on the occurrence of the triggering event, wherein the account is associated with a pre-paid credit card that is issued upon occurrence of the triggering event.

26. The computer program product of claim 19, wherein the set of codes for causing the computer to provide the monetary reward further cause the computer to provide the monetary reward to the account that is only available to the account holder based on the occurrence of the triggering event, wherein the account holder is someone other than (1) the customer or (2) someone residing in a household of the customer.

27. The computer program product of claim 19, wherein the set of codes for causing the computer to provide the monetary reward further cause the computer to provide the monetary reward to the account that is only available to the account holder based on the occurrence of the triggering event, wherein the account is external to the entity implementing the purchase offer program.
